(19) United States
(12) Patent Application Publication
(10) Pub. No.: US 2026/0261421 A1
(43) Pub. Date: Sep. 3, 2026

(54) IMPLEMENTATION METHOD FOR SECURITY DEVICE AND SECURITY DEVICE

(71) Applicant: Feitian Technologies Co., Ltd., Beijing (CN)

(72) Inventor: Zhou LU, Beijing (CN)

(73) Assignee: Feitian Technologies Co., Ltd., Beijing (CN)

(21) Appl. No.: 18/995,876

(22) PCT Filed: May 23, 2023
(86) PCT No.: PCT/CN2023/095726

§ 371 Date: Jan. 17, 2025

(30) Foreign Application Priority Data
Jul. 21, 2022 (CN) 202210855758.8

(51) Int. Cl. H04L 9/32; H04L 9/08

(52) U.S. Cl. CPC H04L 9/3234; H04L 9/0825; H04L 9/0861; H04L 9/3247; H04L 9/3263

(57) ABSTRACT

The disclosure discloses an implementation method for a security device and a security device, the method includes: an FIDO HID interface of the security device receives an instruction, when it is determined that the received instruction is a preset FIDO instruction, the security device parses the preset FIDO instruction to obtain a preset parameter, obtains a functional instruction according to the preset parameter, and determines a type of the function instruction, when the functional instruction is a certificate request generation instruction, the security device generates a key pair and stores the key pair in a storage file, signs user input information in the certificate request generation instruction and a public key of the key pair with a private key of the key pair to generate a signature value, and sends the signature value, the public key of the key pair, and the user input information to the client.

### CROSS-REFERENCE TO RELATED APPLICATION

The present application is a National stage of International Application No. PCT/CN2023/095726, filed on May 23, 2023, which claims priority to Chinese Patent Application No. 202210855758.8, filed with China National Intellectual Property Administration on Jul. 21, 2022 and entitled “IMPLEMENTATION METHOD FOR SECURITY DEVICE AND SECURITY DEVICE”. The above applications are hereby incorporated by reference in their entireties.

### TECHNICAL FIELD

The present disclosure relates to the field of information security and, in particular, to an implementation method for a security device and a security device.

### BACKGROUND

In the prior art, the security device used in the traditional PKI (Public Key Infrastructure) system requires to install different plug-ins to access the server through different browsers, which limits the application scope of the security device used in the PKI system.

### SUMMARY

The present disclosure provides an implementation method for a security device and a security device, which solves the above technical problem.

The implementation method for a security device includes:
step 1, waiting, by a security device, for receiving an instruction sent by a client;
step 2, determining whether the received instruction is a preset FIDO (Fast Identity Online) instruction when a first interface of the security device receives the instruction, if yes, performing step 3, if not, performing corresponding operation of the instruction and performing step 1, where the first interface is a FIDO HID interface;
step 3, parsing, by the security device, the preset FIDO instruction to obtain a preset parameter, obtaining a functional instruction according to the preset parameter, determining a type of the functional instruction, and performing step 4 when the functional instruction is a certificate request generation instruction, or performing step 5 when the function instruction is a writing certificate object instruction;
step 4, generating, by the security device, a key pair and storing the key pair in a storage file, signing user input information in the certificate request generation instruction and a public key of the key pair with a private key of the key pair to generate a signature value, generating a response to the certificate request generation instruction according to the signature value, the public key of the key pair and the user input information, generating response data according to the response to the certificate request generation instruction, generating a response to the preset FIDO instruction according to the response data, sending the response to the preset FIDO instruction to the client, and performing step 1; and
step 5, writing, by the security device, certificate data in the writing certificate object instruction into the storage file, constituting response data according to a successful status code, generating a response to the preset FIDO instruction according to the response data, sending the response to the preset FIDO instruction to the client, and performing step 1.

The security device includes:
a wait-to-receive module, configured to wait for receiving an instruction sent by a client;
a receiving module, configured to receive the instruction sent by the client;
a first determining and triggering module, configured to determine whether the received instruction is a preset FIDO instruction when the receiving module receives the instruction through a first interface, and further configured to trigger a parsing module when a determined result of a first determining and triggering module is yes, or to trigger a first operating module when the determined result of a second determining and triggering module is not, where the first interface is a FIDO HID interface;
the first operating module, configured to perform corresponding instruction operation when triggered by the first determining and triggering module;
the parsing module, configured to parse the preset FIDO instruction to obtain a preset parameter, and obtain a functional instruction according to the preset parameter;
the second determining and triggering module, configured to determine a type of the functional instruction obtained by the parsing module, and trigger a second operating module when it is determined that the functional instruction is a certificate request generation instruction, or trigger a third operating module when it is determined that the functional instruction is a writing certificate object instruction;
the second operating module, configured to generate a key pair when triggered by the second determining and triggering module and store the key pair in a storage file, sign input information in the certificate request generation instruction and a public key of the key pair with a private key of the key pair to generate a signature value, generate a response to the certificate request generation instruction according to the signature value, the public key of the key pair and the user input information, generate response data according to the response to the certificate request generation instruction, generate a response to the preset FIDO instruction according to the response data, send the response to the preset FIDO instruction to the client, and trigger the wait-to-receive module; and
the third operating module, configured to write certificate data in the writing certificate object instruction into the storage file, constitute response data according to successful status code, generate a response to the preset FIDO instruction according to the response data, send the response to the preset FIDO instruction to the client, and trigger the wait-to-receive module.

The present disclosure further provides a security device, including: at least one processor, a memory and instructions stored in the memory and executed by the at least one processor, the at least one processor executes the instructions to implement the above implementation method for the security device.

The present disclosure further provides a computer-readable storage medium, includes a computer program therein, when the computer program runs on a computer, which enable the computer to execute the above implementation method for the security device.

The present disclosure further provides a chip, coupled to a memory and is configured to execute a computer program stored in the memory to implement the above implementation method for the security device.

Beneficial effects of the present disclosure: the present disclosure provides an implementation method for a security device and a security device, where a FIDO interface is added to the security device used in the PKI system, the operation on a certificate is realized through the FIDO interface, and the operation of plug-in free installation for different browsers is realized, thereby expanding the application scope of the security device.

### BRIEF DESCRIPTION OF DRAWINGS

FIGS. 1A-1B are flowcharts of an implementation method for a security device provided by Embodiment 1 of the present disclosure.

FIGS. 2A-2C and FIGS. 3A-3B are flowcharts of an implementation method for a security device provided by Embodiment 2 of the present disclosure.

FIGS. 4A-4C and FIG. 5 are flowcharts of an implementation method for a security device provided by Embodiment 3 of the present disclosure.

### DETAILED DESCRIPTION OF EMBODIMENTS

The technical solutions in the embodiments of the present disclosure will be clearly and completely described below in combination with the accompanying drawings of the embodiments of the present disclosure. It is clear that the embodiments described are a part of the embodiments of the present disclosure, and not all of them. Based on the embodiments in the present disclosure, all other embodiments obtained by those skilled in the art without creative effort fall within the scope of protection of the present disclosure.

The security device in the present application is the security device used in the PKI system.

### Embodiment 1

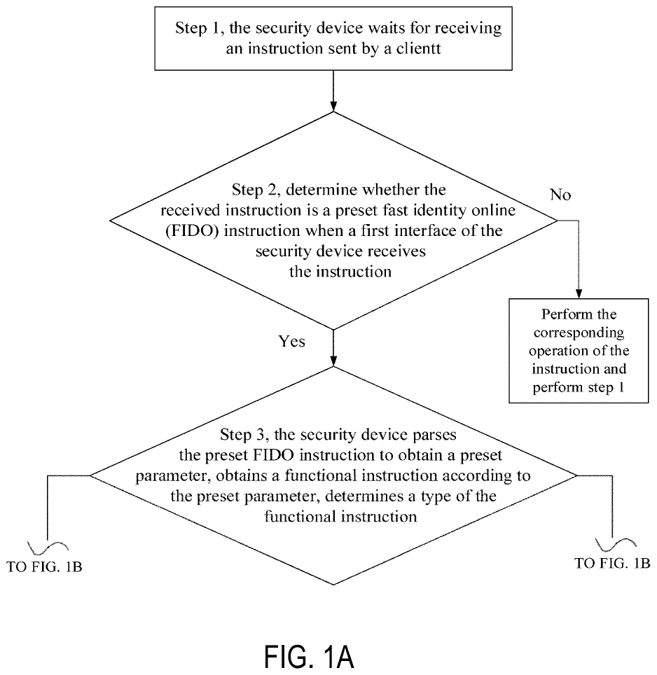

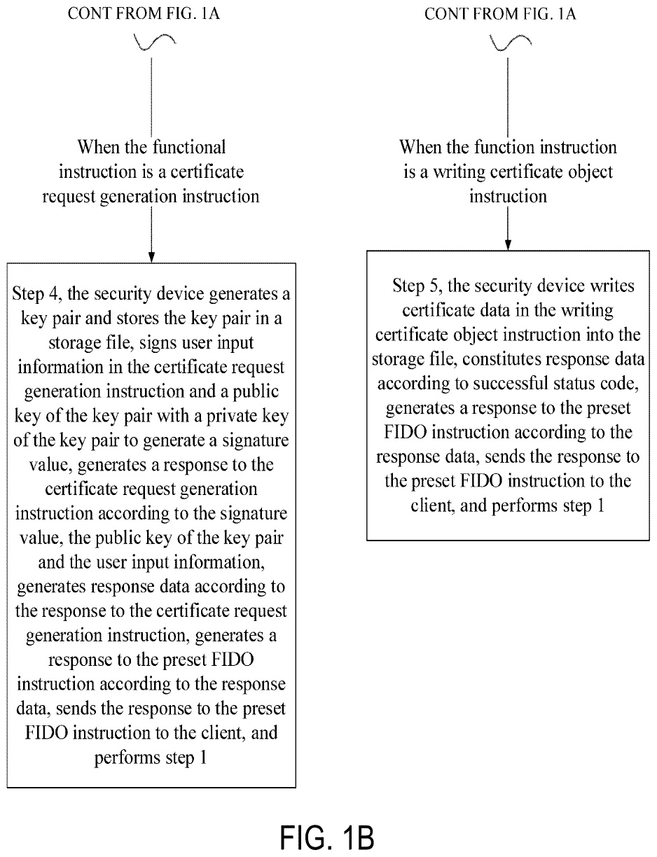

The present disclosure provides an implementation method for a security device, as shown in FIGS. 1A-1B, includes the following steps:
step 1, the security device waits for receiving an instruction sent by a client;
step 2, determine whether the received instruction is a preset FIDO instruction when a first interface of the security device receives the instruction, if yes, perform step 3, if not, perform corresponding operation of the instruction and perform step 1, where the first interface is an FIDO HID interface;
step 3, the security device parses the preset FIDO instruction to obtain a preset parameter, obtains a functional instruction according to the preset parameter, determines a type of the functional instruction, and performs step 4 when the functional instruction is a certificate request generation instruction, or performs step 5 when the function instruction is a writing certificate object instruction;
step 4, the security device generates a key pair and storing the key pair in a storage file, signs user input information in the certificate request generation instruction and a public key of the key pair with a private key of the key pair to generate a signature value, generates a response to the certificate request generation instruction according to the signature value, the public key of the key pair and the user input information, generates response data according to the response to the certificate request generation instruction, generates a response to the preset FIDO instruction according to the response data, sends the response to the preset FIDO instruction to the client, and performs step 1; and
step 5, the security device writes certificate data in the writing certificate object instruction into the storage file, constitutes response data according to successful status code, generates a response to the preset FIDO instruction according to the response data, sends the response to the preset FIDO instruction to the client, and performs step 1.

In a possible implementation, the storage file is a container file, and the container file has a corresponding container identifier.

In a possible implementation, in the step 4, the generating, by the security device, the key pair and storing the key pair in the storage file includes: generating, by the security device, the key pair and storing the key pair in the container file corresponding to a container identifier in the certificate request generation instruction.

In step 5, the writing, by the security device, the certificate data in the writing certificate object instruction into the storage file includes: writing, by the security device, the certificate data in the writing certificate object instruction into the container file corresponding to a container identifier in the writing certificate object instruction.

In a possible implementation, the performing step 4 when the functional instruction is the certificate request generation instruction includes:
the security device determines whether there is the container file corresponding to the container identifier in the certificate request generation instruction, if yes, performs step 4, if not, the security device creates the container file corresponding to the container identifier in the certificate request generation instruction and performs step 4.

In a possible implementation, step 3 further includes:
when the functional instruction is a reading certificate instruction, perform step 6, and when the functional instruction is a signature instruction, perform step 7;
step 6, the security device obtains certificate data from a container file corresponding to a container identifier in the reading certificate instruction, sends the obtained certificate data to the client, and performs step 1;
step 7, the security device obtains a container identifier and information to be signed from the signature instruction, reads a private key from a container file corresponding to a container identifier, signs the information to be signed according to the found private key to obtain a signature result, constitutes a response to the preset FIDO instruction according to the signature result, sends the response to the preset FIDO instruction to the client, and performs step 1.

In a possible implementation, step 2 further includes: when a second interface of the security device receives the instruction and a type of the received instruction is a reading certificate instruction, the security device obtains certificate data from a container file corresponding to the reading certificate instruction, returns the certificate data to the client, and performs step 1.

In a possible implementation, the storage file includes: an IKF (Internal Key File) file, a public area file and a private area file, where the public area file includes a container object, a public key object, an acceleration object and a certificate object, the private area file includes a private key object, the public area file has a corresponding public area file identifier, and the private area file has a corresponding private area file identifier.

In a possible implementation, in step 4, the generating, by the security device, the key pair and storing the key pair in the storage file includes:
step 4-1, the security device generates the key pair and a key identifier and stores the key pair and the key identifier in a preset IKF file;
step 4-2, the security device creates the container object, the public key object, and the private key object;
step 4-3, the security device associates a container name of the container object and a certificate DN (Distinct Name) value in the user input information in the certificate request generation instruction with the key identifier to generate an acceleration object record, and stores the acceleration object record in the acceleration object to update the acceleration object;

In step 5, the writing, by the security device, the certificate data in the writing certificate object instruction into the storage file includes: creating, by the security device, the certificate object and a certificate object identifier according to the certificate data in the writing certificate object instruction, and associating the certificate object identifier with the acceleration object record in the acceleration object corresponding to the certificate DN value in the certificate data to update the acceleration object.

In a possible implementation, step 3 further includes: when the functional instruction is a reading certificate instruction, perform step 6′, when the functional instruction is a signature instruction, perform step 7′;
step 6′, the security device traverses the acceleration object record in the acceleration object according to a certificate DN value or a container name in the reading certificate instruction to find an acceleration object record corresponding to the certificate DN value or the container name, obtains a certificate object identifier from the acceleration object record, obtains certificate data from a certificate object according to the certificate object identifier, generates response data according to the certificate data, constitutes a response to the preset FIDO instruction according to the response data, sends the response to the preset FIDO instruction to the client, and performs step 1;
step 7′, the security device traverses the acceleration object record in the acceleration object according to a certificate DN value or a container name in the signature instruction to find an acceleration object record corresponding to the certificate DN value or the container name, obtains a key identifier from the acceleration object record, finds a corresponding private key from the IKF file according to the key identifier, signs the data to be signed in the signature instruction by using the private key to obtain the signature result, constitutes the response to the preset FIDO instruction according to the signature result, sends the response to the preset FIDO instruction to the client, and performs step 1.

In a possible implementation, step 2 further includes:
when a second interface of the security device receives the instruction and a type of the received instruction is a selecting file instruction and the file identifier in the selecting file instruction is a public area file identifier, perform step a1;
step a1, the security device uses the public area file as a current file;
when the second interface of the security device receives the instruction and the type of the received instruction is a reading instruction, perform step b1;
step b1, the security device sends a container object, a public key object, an acceleration object, and a certificate object in a current file to the client, and returns to step 1.

In a possible implementation, in step 3, the parsing, by the security device, the preset FIDO instruction to obtain the preset parameter, and obtaining the functional instruction according to the preset parameter, and determining the type of the functional instruction includes:
the security device parses the preset FIDO instruction to obtain the preset parameter, converts data of the preset parameter to obtain converted data, decrypts the converted data using a predetermined algorithm to obtain decrypted data, performs a padding data removal operation on the decrypted data to obtain the function instruction, and obtains the type of the function instruction according to an instruction identifier in the function instruction.

In a possible implementation, the generating the response to the preset FIDO instruction according to the response data, and sending the response to the preset FIDO instruction to the client includes: the security device pads the response data according to a predetermined rule to obtain padding data, encrypts the padding data to obtain ciphertext data, uses the ciphertext data as a verification data parameter, constitutes the response to the preset FIDO instruction according to the verification data parameter, and returns the response to the preset FIDO instruction to the client.

### Embodiment 2

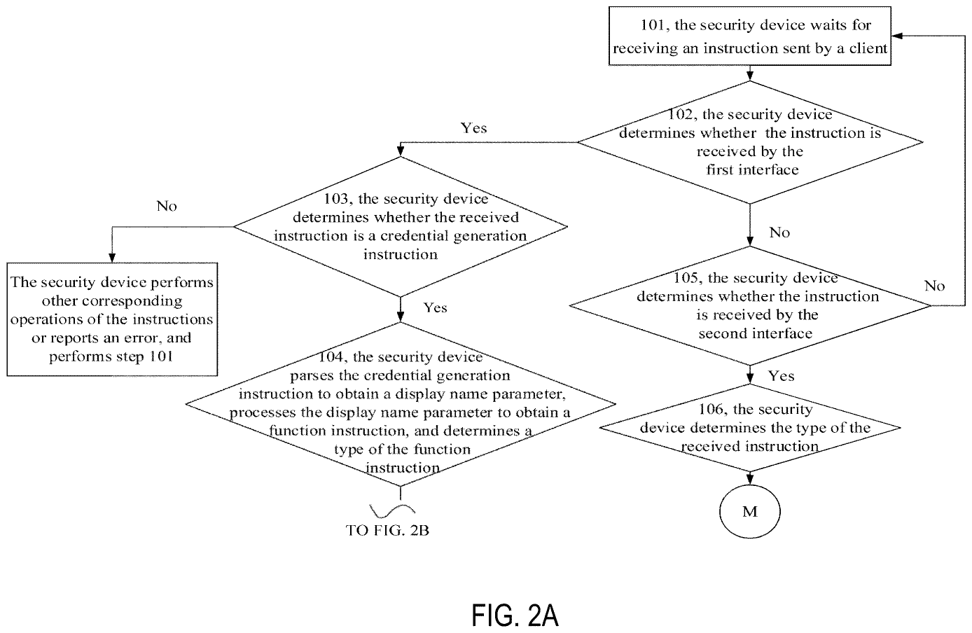

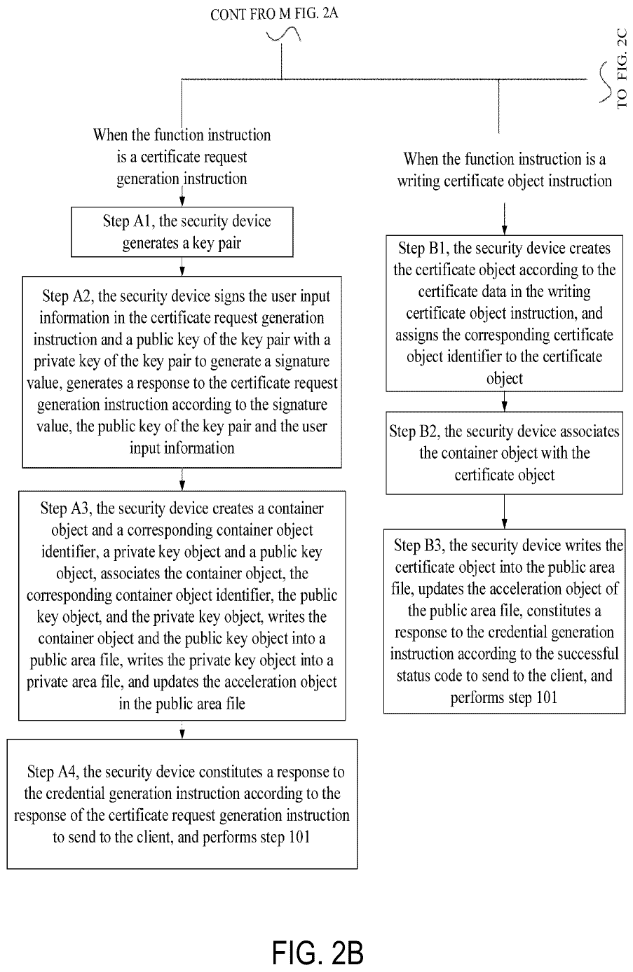

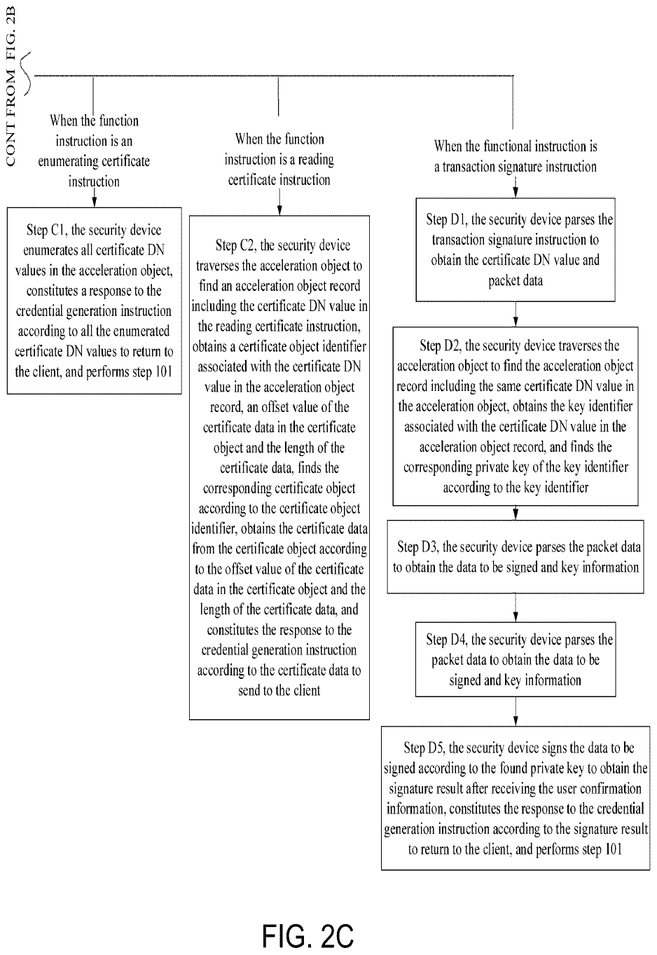

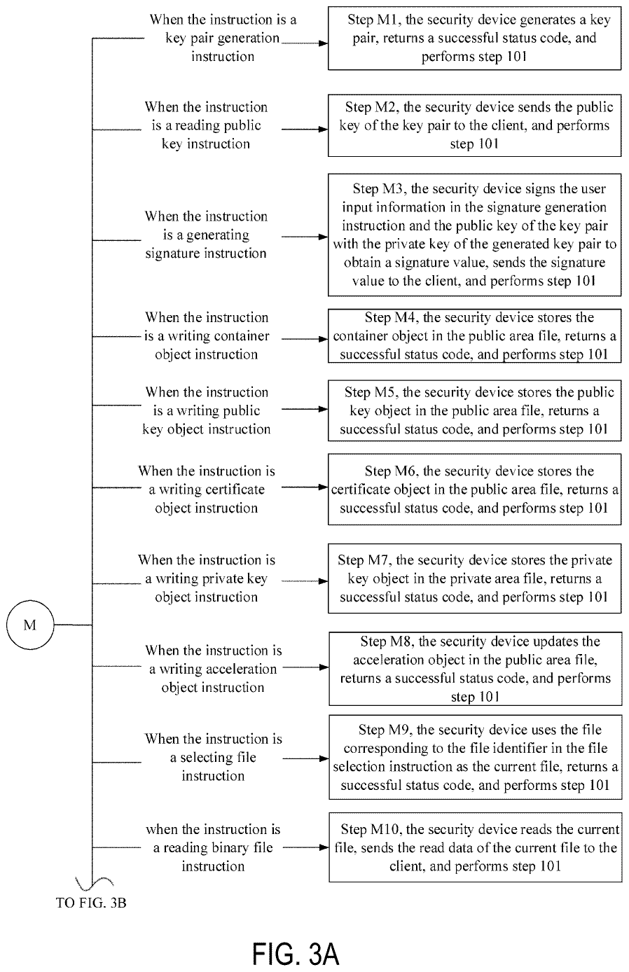

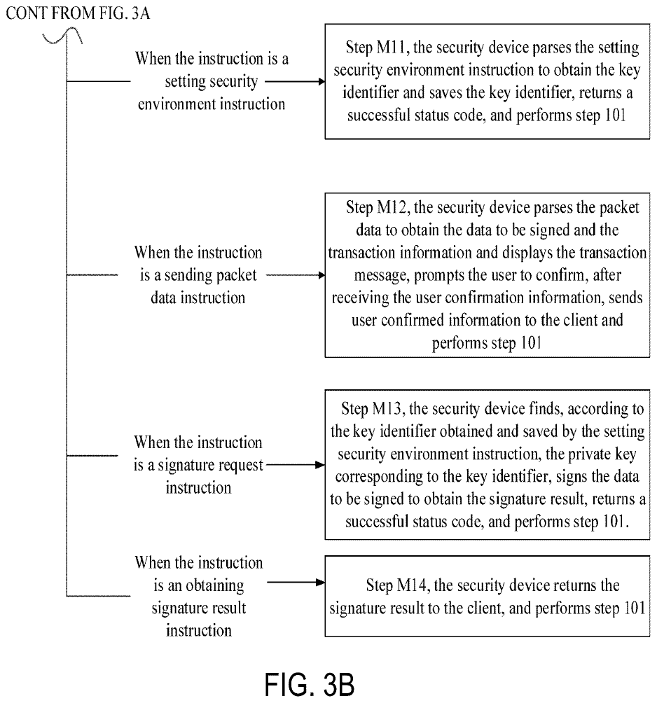

This embodiment provides an implementation method for a security device, as shown in FIGS. 2A-2C and FIGS. 3A-3B, the method includes the following steps.
101, the security device waits for receiving an instruction sent by a client.

In this embodiment, the security device is a composite USB (Universal Serial Bus) device that supports at least two interfaces. In this embodiment, a first interface is a FIDO HID (Human interface Device) interface, and a second interface can be a UMS (Usb Mass Storage) interface, HID interface, CCID (Chip/Smart Card Interface Device) interface or SCSI (Small Computer System Interface) interface.

The first interface supports two endpoints, respectively, an interrupt output endpoint and an interrupt input endpoint.

The second interface supports two endpoints, respectively, a batch output endpoint and a batch input endpoint.

Specifically, the instruction received by the UMS interface, HID interface, CCID interface, and SCSI interface of the security device is sent by the client to the security device through a middleware of the client, and the security device sends an instruction processing result to the middleware of the client through the above interfaces.
102, the security device determines whether the instruction is received by the first interface, if yes, performs step 103, if not, performs step 105.

This step includes: the security device determines whether the instruction is received by the FIDO HID interface, if yes, performs step 103, if not, performs step 105.

The security device determines whether the instruction is received by the FIDO HID interface includes: the security device determines whether the instruction is received by the interrupt output endpoint, if yes, performs step 103, if not, performs step 105.
103, the security device determines whether the received instruction is a credential generation instruction, if yes, performs step 104, if not, the security device performs other corresponding operations of the instructions or reports an error, and performs step 101.
104, the security device parses the credential generation instruction to obtain a display name parameter, processes the display name parameter to obtain a function instruction, and determines a type of the function instruction, and
when the function instruction is a certificate request generation instruction, performs steps A1-A4;
when the function instruction is a writing certificate object instruction, performs steps B1-B3;
when the function instruction is an enumerating certificate instruction, performs step C1;
when the function instruction is a reading certificate instruction, performs step C2;
when the functional instruction is a transaction signature instruction, performs steps D1-D5.

In this step, the parsing, by the security device, the credential generation instruction to obtain a display name parameter, processing the display name parameter to obtain a function instruction, and determining the type of the function instruction includes: the security device parses the credential generation instruction to obtain the display name parameter (Displayname), converts the data of the display name parameter to obtain hexadecimal data, decrypts the hexadecimal data by using the AES-128 algorithm and performs a padding data removal operation on the hexadecimal data to obtain the function instruction, and obtains the type of the function instruction according to the instruction identifier in the function instruction.

Specifically, the security device parses the credential generation instruction to obtain client data hash (clientDataHash), a relying party identifier (rp), user information (user), and an algorithm parameter (pubkeyCredParams), and parses the display name parameter (displayname) from the user information.

For example, the FIDO HID interface of the security device receives, from the client, the credential generation instruction:

01A4015820687134968222EC17202E42505F8ED2B16AE22F16BB05B88C25D B9E602645F14102A26269646861636D652E636F6D646E616D656441636D6503A462696458203082019330820138A0030201023082019330820138A0030201023082019330826469636F6E782868747470733A2F2F706963732E61636D652E636F6D2F30302F702F61426A6A6A707150622E706E67646E616D65766A6F686E70736D697468406578616D706C652E636F 6D6B646973706C61794E616D6578803346383931323845393345323037334631433233423832374343433546414545463838353831384230413530433834464634374137413337373130 363334383645343945433334434131373541463238363241353441464433344445444534353 8383530443037453235304638333235313031444438324445343344323437360482A263616C672664747970656A7075626C69632D6B6579A263616C6739010064747970656A7075626C69632D6B6579.

The security device performs a CBOR (Concise Binary Object Representation) decoding operation on the above credential generation instruction and obtains, from the decoded credential generation instruction, the client data hash (clientDataHash):
015820687134968222EC17202E42505F8ED2B16AE22F16BB05B88C25DB9E6 02645F141;
the relying party identification (rp): 02A26269646861636D65;
the user information (user):
03A462696458203082019330820138A0030201023082019330820138A00302010 23082019330826469636F6E782868747470733A2F2F706963732E61636D652E636F6D2F30 302F702F61426A6A6A707150622E706E67646E616D65766A6F686E70736D69746840657 8616D706C652E636F6D6B646973706C61794E616D65;
the algorithm parameters (pubkeyCredParams):
0482A263616C672664747970656A7075626C69632D6B6579A263616C6739010 064747970656A7075626C69632D6B6579;
parses, from the user information, the display name parameter (displayname): 334638393132384539334532303733463143323342383237434343354641454546 383835383138423041353043383446463437413741333737313036333438364534394543333 443413137354146323836324135344146443334444544453435383835304430374532353046 3833323531303144443832444534334432343736;
converts the data of the display name parameter to obtain the hexadecimal data 3F89128E93E2073F1C23B827CCC5FAEEF885818B0A50C84FF47A7A3771063486E49EC 34CA175AF2862A54AFD34DEDE458850D07E250F8325101DD82DE43D2476, decrypts the hexadecimal data by using the AES-128 algorithm and performs a padding data removal operation on the hexadecimal data to obtain the function instruction 04002D1025D55AD283AA400AF464C76D713C07AD1B520301434E3D5445535430322C4F553D544553542C4F3D49434243, the type of the function instruction obtained according to the instruction identifier 04 in the function instruction is the certificate request generation instruction, and the steps A1-A4 are performed.

In this embodiment, the certificate request generation instruction further includes a key identifier and a certificate type.

In this embodiment, the acquisition process of the writing certificate object instruction, the reading certificate instruction, the transaction signature instruction, and the enumerate certificate instruction is the same as the above example certificate request generation instruction, and no further elaboration.

In this embodiment, the credential generation instruction can be any preset FIDO instruction, and the display name parameter can be a preset parameter of the FIDO instruction with no length limit. For example, when the preset FIDO instruction is a credential generation instruction, the preset parameter can be an extension parameter; when the preset FIDO instruction is a certificate authentication instruction, the preset parameter is a whitelist parameter.
105, the security device determines whether the instruction is received by the second interface, if yes, performs step 106, if not, returns to step 101.

This step includes: the security device determines whether the instruction is received by the batch output endpoint, if yes, performs step 106, if not, returns to step 101.

In this embodiment, the security device can also first determine whether the instruction is received by the second interface, if yes, performs step 106; if not, determines whether the first interface has received the instruction, if yes, performs step 103, if not, returns to step 101.
106, the security device determines the type of the received instruction, when the instruction is a key pair generation instruction, performs step M1; when the instruction is a reading public key instruction, performs step M2; when the instruction is a generating signature instruction, performs step M3; when the instruction is a writing container object instruction, performs step M4; when the instruction is a writing public key object instruction, performs step M5; when the instruction is a writing certificate object instruction, performs step M6; when the instruction is a writing private key object instruction, performs step M7; when the instruction is a writing acceleration object instruction, performs step M8; when the instruction is a selecting file instruction, performs step M9; when the instruction is a reading binary file instruction, performs step M10; when the instruction is a setting security environment instruction, performs step M11; when the instruction is a sending packet data instruction, performs step M12; when the instruction is a signature request instruction, performs step M13; when the instruction is an obtaining signature result instruction, performs step M14.

In this embodiment, the certificate request generation instruction includes the certificate DN value.

Step A1, the security device generates a key pair.

In this step, while the security device generates the key pair, it also generates a key identifier corresponding to the key pair, and stores the public key and the private key of the key pair.
Step A2, the security device signs the user input information in the certificate request generation instruction and a public key of the key pair with a private key of the key pair to generate a signature value, generates a response to the certificate request generation instruction according to the signature value, the public key of the key pair and the user input information.

In this step, the information inputted by the user includes the certificate DN value, where the certificate DN value can be pre-issued by the certification center or obtained by the user according to a predetermined condition.

For example, the response to the certificate request generation instruction generated by the security device is as follows:
424B423074495A6D6956654432677534693972777A764244504B477852506A66 774F745448436B61366F5633792B30567450384E4732787A58644F52352B722B42647A44 4275306A5A516A327A32494239436B565246553D26264D4948724D494750416745424D4 33878447A414E42674E5642414D4D426C5246553151774D6A454E4D4173474131554543 777745564556545644454E4D417347413155454367774553554E43517A425A4D424D4742 797147534D34394167454743437142484D39564159497441304941424B423074495A6D695 6654432677534693972777A764244504B477852506A66774F745448436B61366F5633792B 30567450384E4732787A58644F52352B722B42647A444275306A5A516A327A324942394 36B5652465577444159494B6F45637A3155426733554641414E4A41444247416945417670 756574493835673267754D7A6C4B4D35472B52372F2F4E306B654C5144434C6E50716A4 F3339555951434951447876677267354C4C45644C72353264585A4F6343596B712F495553 4D496F3079304566465331754E6D65413D3D9000.
Step A3, the security device creates a container object and a corresponding container object identifier, a private key object and a public key object, associates the container object, the corresponding container object identifier, the public key object, and the private key object, writes the container object and the public key object into a public area file, writes the private key object into a private area file, and updates the acceleration object in the public area file.

In this embodiment, the private key object includes a key identifier, and the public key object includes a key identifier and a public key of the key pair.

In this embodiment, the security device has a storage area, and the storage area includes an IKF file, a public area file, and a private area file.

The IKF file is an internal key file, i.e. a secret file.

The public area file has a corresponding public area file identifier, and the private area file has a corresponding private area file identifier, both the public area file and the private area file are storage files.

In this embodiment, the step A1 further includes: the security device stores the generated key pair and key identifier in the IKF file.

In this step, the creating, by the security device, the container object and the corresponding container object identifier, private key object and public key object, and associating the container object with the corresponding container object identifier, the public key object, and the private key object includes: creating, by the security device, the container object and the corresponding container object identifier, hashing the public key of the key pair to obtain the container name of the container object, associating the private key object identifier with the public key object identifier, then storing it in the container object.

In this step, the updating the acceleration object in the public area file includes: associating the key identifier, the certificate DN value and the container name of the container object to generate an acceleration object record, and storing the generated acceleration object record in an acceleration object.

In this step, before updating the acceleration object in the public area file, the method further includes: creating the acceleration object and storing the acceleration object in the public area file.
Step A4, the security device constitutes a response to the credential generation instruction according to the response of the certificate request generation instruction to send to the client, and performs step 101.

In this embodiment, specifically, the security device receives the instruction from the FIDO HID interface, and the processing result obtained after processing the instruction is returned to the client through the interrupt input endpoint.

This step includes: padding, by the security device, the response to the certificate request generation instruction according to a predetermined rule to obtain padding data, encrypting the padding data to obtain ciphertext data, using the ciphertext data as a verification data parameter, constituting a response to response to the credential generation instruction according to the verification data parameter, sending it to the client, and performing step 101.

The predetermined rule is: padding a byte 0x80 at the end of the response data of the certificate request generation instruction to obtain the data to be processed, determining whether the data to be processed is an integer multiple of 16 bytes, if it is an integer multiple of 16 bytes, the data to be processed is the padding data, otherwise, padding 0x00 at the end of the data to be processed continuously until the padding data is obtained as an integer multiple of 16 bytes.

For example, the security device pads the response to the certificate request generation instruction 424B423074495A6D6956654432677534693972777A764244504B477852506A66774F74544 8436B61366F5633792B30567450384E4732787A58644F52352B722B42647A444275306A5A516A327A32494239436B565246553D26264D4948724D494750416745424D433878447A 414E42674E5642414D4D426C5246553151774D6A454E4D41734741315545437777455645 56545644454E4D417347413155454367774553554E43517A425A4D424D4742797147534D 34394167454743437142484D39564159497441304941424B423074495A6D6956654432677 534693972777A764244504B477852506A66774F745448436B61366F5633792B3056745038 4E4732787A58644F52352B722B42647A444275306A5A516A327A32494239436B5652465 577444159494B6F45637A3155426733554641414E4A4144424741694541767075657449383 5673267754D7A6C4B4D35472B52372F2F4E306B654C5144434C6E50716A4F3339555951 434951447876677267354C4C45644C72353264585A4F6343596B712F4955534D496F30793 04566465331754E6D65413D3D9000 to obtain the padding data, encrypts the padding data with the AES_128 algorithm to obtain the encrypted data C35F118D4DDE91CC9E7DBD979F7FB584CDFE08016AF092019C1618C36D0A6EB7D1 808717D8A7AB13CEBCE51FB2889DDB000B40E4C74FBEA0542A26A90E424D9B1EB0EDAC6F0A16FF88C517EE7D96CE568E5BEB1D1ACCFCDBFDDC7E52352A5D6A98EB 6BE0F1DC1132B06D513A8108E82BCACD7C87169695E06604A0254BC2F808A6734E8D5AEDEBCA1CA08B003E7D1FB2CBDFBB854850D702421A21F0C2D7013CB13E46EE E939710F60C28F3B20744973BF172BB0E9F662474F2ED938A543282780CB3A349E13D7 00145E41715448A06DC6D70FEA9A6737B6A8EEA320007B90A96DB26F0DF2AE466FA 76576852FF467E3BCD29CFBD3A7751E12E7E05457D16277257035026438887F5A05F77 09A169B6ED01E64D6E084A657DAFEE1C4860A23521AF1313B030478FEF72182905F50 4F9D60F3930900ADCC48EBF286FC4E641405C8367D42DC1636E5AE3AFA1CB1D537F D6FFE8C2B6B31166E63C11CA9ABBA2559BE21394149ABCEA9D0CED41COCAAOC5E 898B07BB475C6ED3E9847E3F9A2D86893FB460E2E252CB24E532357E81E10EA8CD90 218FECC459A3080EAAD833F3CE4F, uses the encrypted data as the verification data parameter (AuthData), constitutes the response to the credential generation instruction according to the verification data parameter, and sends the response to the credential generation instruction to the client.

In this embodiment, when the display name parameter is the writing certificate object instruction, the reading certificate instruction, the transaction signature instruction, the enumerate certificate instruction, the response to the credential generation instruction is constituted in the same manner as the above example credential generation instruction, and no further elaboration.

In this embodiment, after receiving the response to the credential generation instruction sent by the security device, the client sends the response to the credential generation instruction to the authentication server for verification, when the authentication server verifies successfully, the authentication server generates certificate data and returns a result including the successful verification and the certificate data to the client, when the authentication server fails to verify, returns a result including the verification failure to the client.

In this embodiment, after the authentication server verifies successfully, the authentication service signs the public key of the key pair and the user input information, such as the certificate DN value, with its own private key, generates a signature result, and generates the certificate data according to the public key of the key pair, the user input information and the signature result.

When the client receives a successful verification result and the certificate data, the client generates a writing certificate object instruction, and constitutes a credential generation instruction according to the writing certificate object instruction to send to the security device.

Specifically, the writing certificate object instruction includes the certificate DN value and the certificate data.

The writing certificate object instruction can further include the container name and the certificate data.
Step B1, the security device creates the certificate object according to the certificate data in the writing certificate object instruction, and assigns the corresponding certificate object identifier to the certificate object.

In this step, the certificate data includes the public key of the key pair, and the created certificate object includes the certificate data.
Step B2, the security device associates the container object with the certificate object.

This step includes: the security device traverses the acceleration object to determine whether an acceleration object record corresponding to the certificate DN value that is the same as the certificate DN value contained in the writing certificate object instruction is found; if yes, obtains the container object identifier associated with the certificate DN value in the found acceleration object record, finds the corresponding container object according to the container object identifier and stores the certificate object identifier in the container object; if not, the security device returns, an error status code to the client, and performs step 101.

This step can also include: the security device traverses the acceleration object to determine whether an acceleration object record corresponding to the container name that is the same as the container name contained in the writing certificate object instruction is found; if yes, obtains the container object identifier associated with the container name in the found acceleration object record, finds the corresponding container object according to the container object identifier and stores the certificate object identifier in the container object; if not, the security device returns an error status code to the client, and performs step 101.
Step B3, the security device writes the certificate object into the public area file, updates the acceleration object of the public area file, constitutes a response to the credential generation instruction according to the successful status code to send to the client, and performs step 101.

In this step, the updating the acceleration object of the public area file includes: associating the certificate object identifier, an offset value of the certificate data in the certificate object, and the length of the certificate data with the certificate DN value in the acceleration object record found by traversing and its associated key identifier, the container name of the container object, to update the found acceleration object record, and storing the updated acceleration object record in the acceleration object.

In this step, updating the acceleration object of the public area file can also include: associating the certificate object identifier, the offset value of the certificate data in the certificate object, and the length of the certificate data with the container name found by traversing and its associated key identifier, and the certificate DN value to update the found acceleration object record, and storing the updated acceleration object record in the acceleration object.

In this embodiment, the constituting the response to the credential generation instruction according to the successful status code includes: processing the successful status code to obtain a verification data parameter, and constituting the response to the credential generation instruction according to the verification data parameter.

Specifically, the process of processing the successful status code to obtain the verification data parameter is the same as the process of obtaining the verification data parameter according to the response to the certificate request generation instruction in step A4, and no further elaboration.
Step C1, the security device enumerates all certificate DN values in the acceleration object, constitutes a response to the credential generation instruction according to all the enumerated certificate DN values to return to the client, and performs step 101.

This step can also be: the security device traverses the acceleration object record in the acceleration object, enumerates all container names in the acceleration object, constitutes the response to the credential generation instruction according to all the enumerated container names to return to the client, and performs step 101.

The constituting the response to the credential generation instruction according to all the enumerated certificate DN values or container name includes: processing all the enumerated certificate DN values or container names to obtain a verification data parameter, and constituting the response to the credential generation instruction according to the verification data parameter.

Specifically, the process of processing all the enumerated certificate DN values or container names to obtain the verification data parameter is the same as the process of obtaining the verification data parameter according to the response to the certificate request generation instruction in step A4, and no further elaboration.

In this step, the client displays all the enumerated certificate DN values or container names based on the response to the credential generation instruction for the user to select, and constitutes a reading certificate instruction based on the certificate DN value or container name selected by the user.
Step C2, the security device traverses the acceleration object to find an acceleration object record including the certificate DN value in the reading certificate instruction, obtains a certificate object identifier associated with the certificate DN value in the acceleration object record, an offset value of the certificate data in the certificate object and the length of the certificate data, finds the corresponding certificate object according to the certificate object identifier, obtains the certificate data from the certificate object according to the offset value of the certificate data in the certificate object and the length of the certificate data, and constitutes the response to the credential generation instruction according to the certificate data to send to the client, and performs step 101.

In this step, the certificate DN value can also be the container name.

In this embodiment, after receiving the response to the credential generation instruction, the client sends the certificate data in the response to the credential generation instruction to the transaction server, so that the transaction server performs signature verification on the signature result sent by the client using the certificate data.

The constituting the response to the credential generation instruction according to the certificate data includes: processing the certificate data to obtain the verification data parameter, and constituting the response to the credential generation instruction according to the verification data parameter.

Specifically, the process of processing the certificate data to obtain the verification data parameter is the same as the process of obtaining the verification data parameter according to the response to the certificate request generation instruction in step A4, and no further elaboration.
Step D1, the security device parses the transaction signature instruction to obtain the certificate DN value and packet data.

This step can also be: the security device parses the transaction signature instruction to obtain the container name and packet data.

In this embodiment, the certificate DN value or container name in the transaction signature instruction is the certificate DN value or container name selected by the user when all certificate DN values or container names are enumerated.
Step D2, the security device traverses the acceleration object to find the acceleration object record including the same certificate DN value in the acceleration object, obtains the key identifier associated with the certificate DN value in the acceleration object record, and finds the corresponding private key of the key identifier according to the key identifier.

This step can also be: the security device traverses the acceleration object to find the acceleration object record including the same container name in the acceleration object, obtains the key identifier associated with the container name in the acceleration object record, and finds the private key corresponding to the key identifier according to the key identifier in the IKF file.
Step D3, the security device parses the packet data to obtain the data to be signed and key information.

In this embodiment, the key information is, for example, transaction information or partial information extracted from the transaction information.
Step D4, the security device displays the key information and prompts the user for confirmation.
Step D5, the security device signs the data to be signed according to the found private key to obtain the signature result after receiving the user confirmation information, constitutes the response to the credential generation instruction according to the signature result to return to the client, and performs step 101.

In this step, the constituting the response to the credential generation instruction according to the signature result includes: processing the signature result to obtain the verification data parameter, and constituting the response to the credential generation instruction according to the verification data parameter.

Specifically, the process of processing the signature result to obtain the verification data parameter is the same as the process of obtaining the verification data parameter according to the response to the certificate request generation instruction in step A4, and no further elaboration.

In this embodiment, the client sends the signature result obtained by sending the response to the credential generation instruction to the transaction server, and the transaction server performs signature verification on the signature result based on the certificate data.
Step M1, the security device generates a key pair, returns a successful status code to the client, and performs step 101.

In this step, while the key device generates a key pair, a key identifier corresponding to the key pair is also generated.

In this embodiment, specifically, when the security device determines that the UMS interface has received an instruction, it processes the instruction and returns the processing result to the client through the batch input endpoint.
Step M2, the security device sends the public key of the key pair to the client, and performs step 101.

This step includes: the security device sends the public key of the key pair to the middleware of the client, and performs step 101;

In this embodiment, after receiving the public key of the key pair, the client sends the public key of the key pair to the verification server for signature verification. After successful verification, the verification server generates certificate data and sends the certificate data to the middleware of the client.
Step M3, the security device signs the user input information in the signature generation instruction and the public key of the key pair with the private key of the generated key pair to obtain a signature value, sends the signature value to the client, and performs step 101.

In this embodiment, after step M3 is performed, the middleware of the client receives the signature value, and constitutes a certificate generation request according to the public key of the key pair, signature value and user input information, and sends the certificate generation request to the server; the server performs signature verification on the signature value in the certificate generation request according to the public key of the key pair in the certificate generation request, when the server successfully verifies the signature value, the server generates certificate data and returns the verification successful result and certificate data to the middleware of the client; when the server fails to verify the signature value, the server returns a verification failure message to the middleware of the client.
Step M4, the security device stores the container object in the public area file, returns a successful status code, and performs step 101.
Step M5, the security device stores the public key object in the public area file, returns a successful status code, and performs step 101.
Step M6, the security device stores the certificate object in the public area file, returns a successful status code, and performs step 101.

In this embodiment, after receiving the certificate data sent by the verification server, the middleware of the client creates a certificate object according to the certificate data, and constitutes a writing certificate object instruction according to the certificate object.
Step M7, the security device stores the private key object in the private area file, returns a successful status code, and performs step 101.
Step M8, the security device updates the acceleration object in the public area file, returns a successful status code, and performs step 101.

In this step, the updating, by the security device, the acceleration object in the public area file includes: associating, by the security device, the associated key identifier, a key type, a certificate type, a container object identifier, a certificate DN value, a container name of the container object, a certificate object identifier, an offset value of the certificate data in the certificate object, and the length of the certificate data in the writing acceleration object instruction and storing them in the acceleration object.

In this embodiment, the writing container object instruction, the writing public key object instruction, the writing certificate object instruction and the writing private key object instruction, and the writing acceleration object instruction are all writing binary instructions; the writing container object instruction includes the container object; the writing public key object instruction includes the public key object; the writing certificate object instruction includes the certificate object; the writing private key object instruction includes the private key object.
Step M9, the security device uses the file corresponding to the file identifier in the file selection instruction as the current file, returns a successful status code, and performs step 101.

In this step, the file identifier is a public area file identifier or a private area file identifier, and the file corresponding to the file instruction identifier is the public area file or the private area file.
Step M10, the security device reads the current file, sends the read data of the current file to the client, and performs step 101.

When the current file in step M9 is the public area file, this step includes: the security device reads the public area file, sends the container object, public key object, certificate object and acceleration object in the public area file to the middleware of the client, and performs step 101.

In a possible implementation, after obtaining the container object, the public key object, the certificate object, and the acceleration object of the security device, the middleware of the client associates the container object, the public key object, and the certificate object, and generates a certificate list for the user to select the required certificate according to the certificate in the certificate object, after receiving the certificate selected by the user, the container name is calculated according to the public key in the certificate data of the certificate, the acceleration object is traversed, and the key identifier associated with the calculated container name is found in the acceleration object, and a setting security environment instruction is generated according to the obtained key identifier.

In a possible implementation, after obtaining the container object, the public key object, the certificate object, and the acceleration object of the security device, the middleware of the client associates the container object, the public key object, and the certificate object, and generates an object list for the user to select the required certificate according to the certificate in the certificate object, after receiving the certificate selected by the user, the container name is calculated according to the public key in the certificate data of the certificate, the container object corresponding to the container name is found, and the public key object and private key object are obtained after parsing the container object, the key identifier is obtained from the public key object or from the private key object, and the setting security environment instruction is generated according to the obtained key identifier.
Step M11, the security device parses the setting security environment instruction to obtain the key identifier and saves the key identifier, returns a successful status code, and performs step 101.
Step M12, the security device parses the packet data to obtain the data to be signed and the transaction information and displays the transaction message, prompts the user to confirm, after receiving the user confirmation information, sends user confirmed information to the client and performs step 101.
Step M13, the security device finds, according to the key identifier obtained and saved by the setting security environment instruction, the private key corresponding to the key identifier, signs the data to be signed to obtain the signature result, returns a successful status code, and performs step 101.

In this embodiment, through steps M9, M10, M11 and M13, the security device implements enumeration through the PKI interface and use of certificates created through the FIDO interface.
Step M14, the security device returns the signature result to the client, and performs step 101.

In this embodiment, the determining the type of the function instruction in step 104 may further include: verifying, by the security device, the PIN code in the PIN code verification instruction when the type of the function instruction is a PIN code verification instruction, if the verification is successful, setting the security status identifier of the security device itself to a predetermined value, generating the response to the credential generation instruction according to the status code of successful verification, and returning it to the client, and performing step 101.

If the verification fails, generating the response to the credential generation instruction according to the status code of the verification failure, and returning it to the client, and performing step 101.

The determining the type of the received instruction in the step 106 may further include: verifying, by the security device, the PIN code in the PIN code verification instruction when the type of the instruction is a PIN code verification instruction, if the verification is successful, setting the security status identifier of the security device itself to a predetermined value and returning the status code of successful verification to the client, if the verification fails, returning the status code of the verification failure to the client.

Correspondingly, before the security device reads or writes the public area file or private area file, the security device needs to determine whether its own security status identifier meets the reading or writing permissions of the current file, if yes, the reading or writing operation is performed on the public area file or private area file, and the read data or the status code of successful writing is returned, if not, the status code of failure to read or write data is returned.

### Embodiment 3

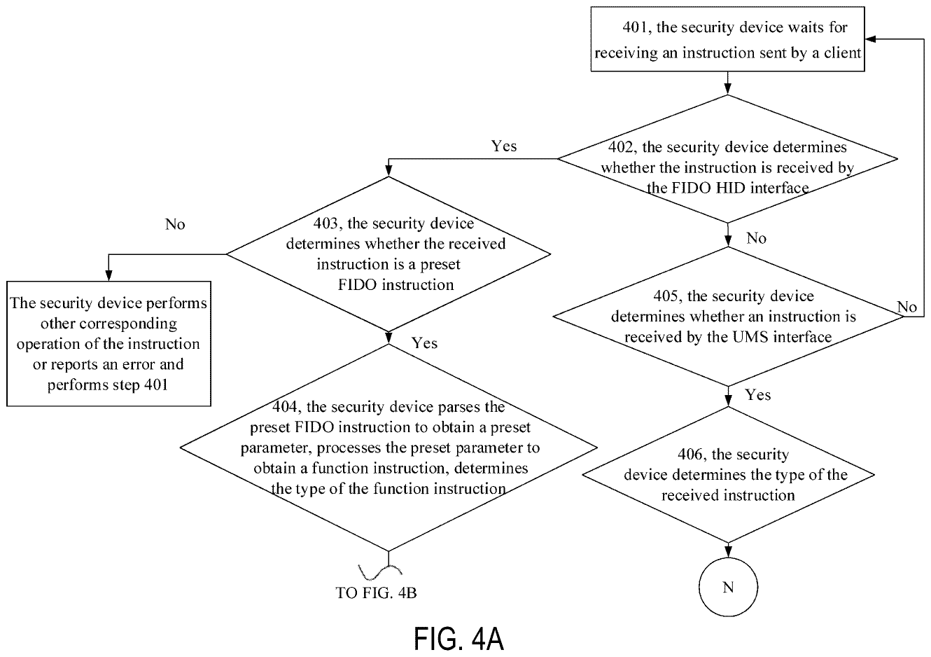

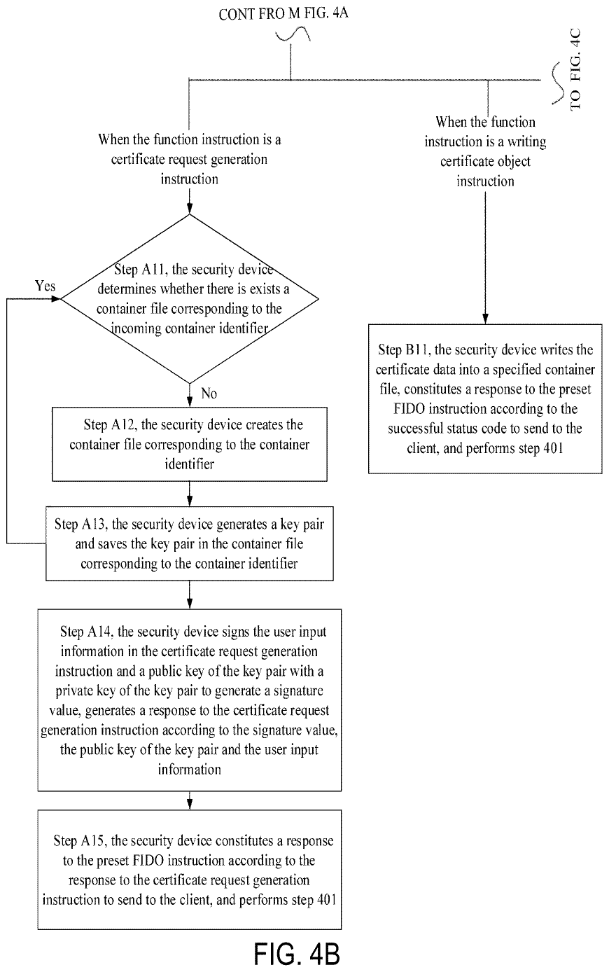

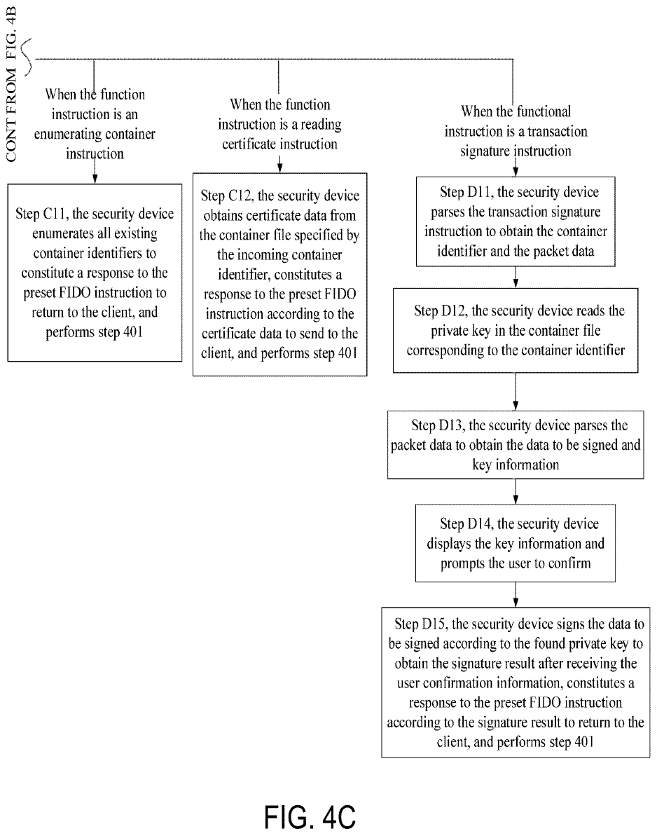

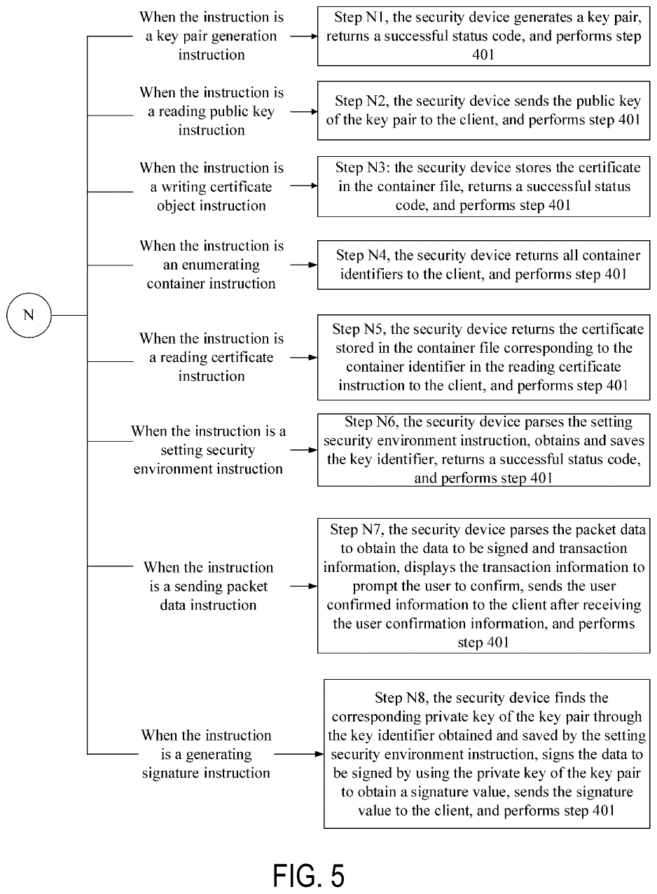

This embodiment provides an implementation method for a security device, as shown in FIGS. 4A-4C and FIG. 5, including the following steps.
Step 401, the security device waits for receiving an instruction sent by a client.
Step 402, the security device determines whether the instruction is received by the FIDO HID interface, if yes, performs step 403, if not, performs step 405.

In this embodiment, the security device is a composite USB device that supports at least two interfaces. In this embodiment, a first interface is a FIDO HID interface, and a second interface can be a UMS interface, a HID interface, a CCID interface or a SCSI interface.

In this embodiment, the second interface is a UMS interface as an example for explanation, but this does not constitute a limitation on the present disclosure.
Step 403, the security device determines whether the received instruction is a preset FIDO instruction, if yes, performs step 404, if not, the security device performs other corresponding operation of the instruction or reports an error and performs step 401.
Step 404, the security device parses the preset FIDO instruction to obtain a preset parameter, processes the preset parameter to obtain a function instruction, determines the type of the function instruction, and when the function instruction is a certificate request generation instruction, performs step A11; when the function instruction is a writing certificate object instruction, performs step B11, when the function instruction is an enumerating container instruction, performs step C11; when the function instruction is a reading certificate instruction, performs step C12; when the functional instruction is a transaction signature instruction, performs step D11.

In this embodiment, the preset FIDO instruction can be any FIDO instruction, and the preset parameter is a parameter with no length limit in the corresponding preset FIDO instruction, for example, the preset FIDO instruction can be a credential generation instruction, then the preset parameter can be a display name parameter or an extension parameter; the preset FIDO instructions can also be a certificate authentication instructions, and the preset parameter is a whitelist parameter.
Step 405, the security device determines whether an instruction is received by the UMS interface, if yes, performs step 406, if not, returns to step 401.
Step 406, the security device determines the type of the received instruction, when the instruction is a key pair generation instruction, performs step N1; when the instruction is a reading public key instruction, performs step N2; when the instruction is a writing certificate object instruction, performs step N3; when the instruction is an enumerating container instruction, performs step N4; when the instruction is a reading certificate instruction, performs step N5; when the instruction is a setting security environment instruction, performs step N6; when the instruction is a sending packet data instruction, performs step N7; when the instruction is a generating signature instruction, performs step N8.
Step A11, the security device determines whether there is exists a container file corresponding to the incoming container identifier, if yes, performs step A13, if not, performs step A12.
Step A12, the security device creates the container file corresponding to the container identifier.
Step A13, the security device generates a key pair and saves the key pair in the container file corresponding to the container identifier.
Step A14, the security device signs the user input information in the certificate request generation instruction and a public key of the key pair with a private key of the key pair to generate a signature value, generates a response to the certificate request generation instruction according to the signature value, the public key of the key pair and the user input information.
Step A15, the security device constitutes a response to the preset FIDO instruction according to the response to the certificate request generation instruction to send to the client, and performs step 401.
Step B11, the security device writes the certificate data into a specified container file, constitutes a response to the preset FIDO instruction according to the successful status code to send to the client, and performs step 401.
Step C11, the security device enumerates all existing container identifiers to constitute a response to the preset FIDO instruction to return to the client, and performs step 401.
Step C12, the security device obtains certificate data from the container file specified by the incoming container identifier, constitutes a response to the preset FIDO instruction according to the certificate data to send to the client, and performs step 401.
Step D11, the security device parses the transaction signature instruction to obtain the container identifier and the packet data.
Step D12, the security device reads the private key in the container file corresponding to the container identifier.
Step D13, the security device parses the packet data to obtain the data to be signed and key information.
Step D14, the security device displays the key information and prompts the user to confirm.
Step D15, the security device signs the data to be signed according to the found private key to obtain the signature result after receiving the user confirmation information, constitutes a response to the preset FIDO instruction according to the signature result to return to the client, and performs step 401.
Step N1, the security device generates a key pair, returns a successful status code, and performs step 401.
Step N2, the security device sends the public key of the key pair to the client, and performs step 401.
Step N3, the security device stores the certificate in the container file, returns a successful status code, and performs step 401.
Step N4, the security device returns all container identifiers to the client, and performs step 401.
Step N5, the security device returns the certificate stored in the container file corresponding to the container identifier in the reading certificate instruction to the client, and performs step 401.
Step N6, the security device parses the setting security environment instruction, obtains and saves the key identifier, returns a successful status code, and performs step 401.
Step N7, the security device parses the packet data to obtain the data to be signed and transaction information, displays the transaction information to prompt the user to confirm, sends the user confirmed information to the client after receiving the user confirmation information, and performs step 401.
Step N8, the security device finds the corresponding private key of the key pair through the key identifier obtained and saved by the setting security environment instruction, signs the data to be signed by using the private key of the key pair to obtain a signature value, sends the signature value to the client, and performs step 401.

In a possible embodiment, after the security device sends the certificates stored in all container files to the client, the middleware generates a certificate list according the certificates for the user to select. After the user selects a required certificate, the middleware generates the setting security environment instruction according to the container identifier corresponding to the certificate.

In this embodiment, through steps N4, N5, N6 and N8, the security device implements enumeration through the PKI interface and use of certificates created through the FIDO interface.

An embodiment of the present application further provides a security device, including:
a wait-to-receive module, configured to wait for receiving an instruction sent by a client;
a receiving module, configured to receive the instruction sent by the client; a first determining and triggering module, configured to determine whether the received instruction is a preset FIDO instruction when the receiving module receives the instruction through a first interface, and further configured to trigger a parsing module when a determined result of a first determining and triggering module is yes, or to trigger a first operating module when the determined result of a second determining and triggering module is not, where the first interface is a FIDO HID interface;
the first operating module, configured to perform corresponding instruction operation when triggered by the first determining and triggering module;
the parsing module, configured to parse the preset FIDO instruction to obtain a preset parameter, and obtain a functional instruction according to the preset parameter;
a second determining and triggering module, configured to determine a type of the functional instruction obtained by the parsing module, and trigger a second operating module when it is determined that the functional instruction is a certificate request generation instruction, or trigger a third operating module when it is determined that the functional instruction is a writing certificate object instruction;
a second operating module, configured to generate a key pair when triggered by the second determining and triggering module and store the key pair in a storage file, sign input information in the certificate request generation instruction and a public key of the key pair with a private key of the key pair to generate a signature value, generate a response to the certificate request generation instruction according to the signature value, the public key of the key pair and the user input information, generate response data according to the response to the certificate request generation instruction, generate a response to the preset FIDO instruction according to the response data, send the response to the preset FIDO instruction to the client, and trigger the wait-to-receive module; and
the third operating module, configured to write certificate data in the writing certificate object instruction into the storage file, constitute the response data according to a successful status code, generate a response to the preset FIDO instruction according to the response data, send the response to the preset FIDO instruction to the client, and trigger the wait-to-receive module.

Optionally, an embodiment of the present application further provide a security device. The security device includes at least one processor, a memory and instructions stored in the memory and executable by the at least one processor, the at least one processor executes the instructions to implement the method in above embodiments. When the device is a chip system, it may be composed of a chip or may include a chip and other discrete devices, which are not specifically limited in the embodiments of the present application; the chip coupled to the memory and is configured to execute the computer program stored in the memory to execute the method disclosed in above embodiments.

In the above embodiments, it may be implemented in whole or in part by software, hardware, firmware, or any combination thereof. When implemented by using a software program, it may be implemented in whole or in part in the form of a computer program product. The computer program product includes one or more computer programs. When the computer program is loaded and executed, the processes or functions described in the embodiments of the present application are generated in whole or in part. The computer program may be stored in the computer-readable storage medium or be transmitted from one computer-readable storage medium to another, for example, the computer instructions may be transmitted from a base station, server or data center via wired (e.g., Coaxial cable, optical fiber, digital subscriber line (digital subscriber line, DSL)) or wireless (e.g., infrared, wireless, microwave, etc.) means to another base station, server or data center. The computer-readable storage medium may be any available medium that can be accessed by the device of the present disclosure or may include one or more data storage devices such as servers and data centers that can be integrated with the medium. The available media may be a magnetic media (e.g., a soft disk, a hard disk, a magnetic tape), optical media (e.g., a DVD (Digital Video Disc)), or semiconductor media (e.g., a solid state disk (solid state disk, SSD)), etc.

Although the present application has been described herein in combination with every embodiment, in the process to practice the claimed application, those skilled in the art will understand and realize other variations of the disclosed embodiments by reviewing the accompanying drawings, the disclosed content, and the appended claims. In the claims, the word “comprising” (comprising) does not exclude other components or steps, and “a” or “an” does not exclude a plurality. A single processor or other unit may perform several of the functions recited in the claims. The certain measures are recited in mutually different dependent claims does not mean that these measures cannot be combined to generate advantageous effects.

The above are only specific embodiments of the present disclosure, but the protection scope of the present disclosure is not limited thereto. Any person familiar with the technical field can easily think of changes or substitutions within the technical scope disclosed by the present disclosure, which should be covered by the protection scope of the present disclosure. Therefore, the protection scope of the present disclosure should be determined by the protection scope of the claims.

1. An implementation method for a security device, comprising:
step 1, waiting, by the security device, for receiving an instruction sent by a client;
step 2, determining whether the received instruction is a preset fast identity online (FIDO) instruction when a first interface of the security device receives the instruction, based on that the received instruction is the preset FIDO instruction, performing step 3, based on that the received instruction is not the preset FIDO instruction, performing corresponding operation of the instruction and performing step 1, wherein the first interface is a fast identity online human interface device (FIDO HID) interface;
step 3, parsing, by the security device, the preset FIDO instruction to obtain a preset parameter, obtaining a functional instruction according to the preset parameter, determining a type of the functional instruction, and performing step 4 when the functional instruction is a certificate request generation instruction, or performing step 5 when the function instruction is a writing certificate object instruction;
step 4, generating, by the security device, a key pair and storing the key pair in a storage file, signing user input information in the certificate request generation instruction and a public key of the key pair with a private key of the key pair to generate a signature value, generating a response to the certificate request generation instruction according to the signature value, the public key of the key pair and the user input information, generating response data according to the response to the certificate request generation instruction, generating a response to the preset FIDO instruction according to the response data, sending the response to the preset FIDO instruction to the client, and performing step 1; and
step 5, writing, by the security device, certificate data in the writing certificate object instruction into the storage file, constituting response data according to a successful status code, generating a response to the preset FIDO instruction according to the response data, sending the response to the preset FIDO instruction to the client, and performing step 1.

2. The method according to claim 1, wherein the storage file is a container file, and the container file has a corresponding container identifier.

3. The method according to claim 2, wherein in the step 4, the generating, by the security device, the key pair and storing the key pair in the storage file comprises: generating, by the security device, the key pair and storing the key pair in the container file corresponding to the container identifier in the certificate request generation instruction;
wherein in the step 5, the writing, by the security device, the certificate data in the writing certificate object instruction into the storage file comprises: writing, by the security device, the certificate data in the writing certificate object instruction into the container file corresponding to the container identifier in the writing certificate object instruction.

4. The method according to claim 2, wherein the performing step 4 when the functional instruction is the certificate request generation instruction comprises:
determining, by the security device, whether there is the container file corresponding to the container identifier in the certificate request generation instruction, based on that there is the container file corresponding to the container identifier in the certificate request generation instruction, performing step 4, based on that there is not the container file corresponding to the container identifier in the certificate request generation instruction, creating, by the security device, the container file corresponding to the container identifier in the certificate request generation instruction and performing step 4.

5. The method according to claim 3, wherein step 3 further comprises:
when the functional instruction is a reading certificate instruction, performing step 6, and when the functional instruction is a signature instruction, performing step 7;
step 6, obtaining, by the security device, certificate data from a container file corresponding to a container identifier in the reading certificate instruction, sending the obtained certificate data to the client, and performing step 1;
step 7, obtaining, by the security device, a container identifier and information to be signed from the signature instruction, reading a private key from a container file corresponding to a container identifier, signing the information to be signed according to the found private key to obtain a signature result, constituting a response to the preset FIDO instruction according to the signature result, sending the response to the preset FIDO instruction to the client, and performing step 1.

6. The method according to claim 2, wherein step 2 further comprises: when a second interface of the security device receives the instruction and a type of the received instruction is a reading certificate instruction, obtaining, by the security device, certificate data from a container file corresponding to the reading certificate instruction, returning the certificate data to the client, and performing step 1.

7. The method according to claim 1, wherein the storage file comprises: an internal key file IKF file, a public area file and a private area file, wherein the public area file comprises a container object, a public key object, an acceleration object and a certificate object, the private area file comprises a private key object, the public area file has a corresponding public area file identifier, and the private area file has a corresponding private area file identifier.

8. The method according to claim 7, wherein in the step 4, the generating, by the security device, the key pair and storing the key pair in the storage file comprises:
step 4-1, generating, by the security device, the key pair and a key identifier and storing the key pair and the key identifier in a preset IKF file;
step 4-2, creating, by the security device, the container object, the public key object, and the private key object;
step 4-3, associating, by the security device, a container name of the container object and a certificate distinct name DN value in the user input information in the certificate request generation instruction with the key identifier to generate an acceleration object record, and storing the acceleration object record in the acceleration object to update the acceleration object;
in step 5, the writing, by the security device, the certificate data in the writing certificate object instruction into the storage file comprises: creating, by the security device, the certificate object and a certificate object identifier according to the certificate data in the writing certificate object instruction, and associating the certificate object identifier with the acceleration object record in the acceleration object corresponding to the certificate DN value in the certificate data to update the acceleration object.

9. The method according to claim 8, wherein step 3 further comprises: when the functional instruction is a reading certificate instruction, performing step 6′, when the functional instruction is a signature instruction, performing step 7′;
step 6′, traversing, by the security device, the acceleration object record in the acceleration object according to a certificate DN value or a container name in the reading certificate instruction to find an acceleration object record corresponding to the certificate DN value or the container name, obtaining a certificate object identifier from the acceleration object record, obtaining certificate data from a certificate object according to the certificate object identifier, generating response data according to the certificate data, constituting a response to the preset FIDO instruction according to the response data, sending the response to the preset FIDO instruction to the client, and performing step 1;
step 7′, traversing, by the security device, the acceleration object record in the acceleration object according to a certificate DN value or a container name in the signature instruction to find an acceleration object record corresponding to the certificate DN value or the container name, obtaining a key identifier from the acceleration object record, finding a corresponding private key from the IKF file according to a key identifier, signing data to be signed in the signature instruction by using the private key to obtain a signature result, constituting a response to the preset FIDO instruction according to the signature result, sending the response to the preset FIDO instruction to the client, and performing step 1.

10. The method according to claim 7, wherein step 2 further comprises:
when a second interface of the security device receives the instruction and a type of the received instruction is a selecting file instruction and a file identifier in the selecting file instruction is a public area file identifier, performing step a1;
step a1, using, by the security device, the public area file as a current file;
when the second interface of the security device receives the instruction and the type of the received instruction is a reading instruction, performing step b1;
step b1, sending, by the security device, a container object, a public key object, an acceleration object, and a certificate object in a current file to the client, and returning to step 1.

11. The method according to claim 1, wherein in step 3, the parsing, by the security device, the preset FIDO instruction to obtain the preset parameter, obtaining the functional instruction according to the preset parameter, and determining the type of the functional instruction comprises:
parsing, by the security device, the preset FIDO instruction to obtain the preset parameter, converting data of the preset parameter to obtain converted data, decrypting the converted data using a predetermined algorithm to obtain decrypted data, performing a padding data removal operation on the decrypted data to obtain the function instruction, and obtaining the type of the function instruction according to an instruction identifier in the function instruction.

12. The method according to claim 1, wherein the generating the response to the preset FIDO instruction according to the response data, and sending the response to the preset FIDO instruction to the client comprises: padding, by the security device, the response data according to a predetermined rule to obtain padding data, encrypting the padding data to obtain ciphertext data, using the ciphertext data as a verification data parameter, constituting the response to the preset FIDO instruction according to the verification data parameter, and returning the response to the preset FIDO instruction to the client.

13. (canceled)

14. A security device, comprising: at least one processor, a memory and instructions stored in the memory and executable by the at least one processor, the at least one processor executes the instructions to cause the processor to execute steps of:
step 1, waiting for receiving an instruction sent by a client;
step 2, determining whether the received instruction is a preset fast identity online (FIDO) instruction when a first interface of the security device receives the instruction, based on that the received instruction is the preset FIDO instruction, performing step 3, based on that the received instruction is not the preset FIDO instruction, performing corresponding operation of the instruction and performing step 1, wherein the first interface is a fast identity online human interface device (FIDO HID) interface;
step 3, parsing the preset FIDO instruction to obtain a preset parameter, obtaining a functional instruction according to the preset parameter, determining a type of the functional instruction, and performing step 4 when the functional instruction is a certificate request generation instruction, or performing step 5 when the function instruction is a writing certificate object instruction;
step 4, generating a key pair and storing the key pair in a storage file, signing user input information in the certificate request generation instruction and a public key of the key pair with a private key of the key pair to generate a signature value, generating a response to the certificate request generation instruction according to the signature value, the public key of the key pair and the user input information, generating response data according to the response to the certificate request generation instruction, generating a response to the preset FIDO instruction according to the response data, sending the response to the preset FIDO instruction to the client, and performing step 1; and
step 5, writing certificate data in the writing certificate object instruction into the storage file, constituting response data according to a successful status code, generating a response to the preset FIDO instruction according to the response data, sending the response to the preset FIDO instruction to the client, and performing step 1.

15. non-transitory computer-readable storage medium, comprises a computer program therein, when the computer program runs on a computer, the processor executes steps of:
step 1, waiting for receiving an instruction sent by a client;
step 2, determining whether the received instruction is a preset fast identity online (FIDO) instruction when a first interface of the security device receives the instruction, based on that the received instruction is the preset FIDO instruction, performing step 3, based on that the received instruction is not the preset FIDO instruction, performing corresponding operation of the instruction and performing step 1, wherein the first interface is a fast identity online human interface device (FIDO HID) interface;
step 3, parsing the preset FIDO instruction to obtain a preset parameter, obtaining a functional instruction according to the preset parameter, determining a type of the functional instruction, and performing step 4 when the functional instruction is a certificate request generation instruction, or performing step 5 when the function instruction is a writing certificate object instruction;
step 4, generating a key pair and storing the key pair in a storage file, signing user input information in the certificate request generation instruction and a public key of the key pair with a private key of the key pair to generate a signature value, generating a response to the certificate request generation instruction according to the signature value, the public key of the key pair and the user input information, generating response data according to the response to the certificate request generation instruction, generating a response to the preset FIDO instruction according to the response data, sending the response to the preset FIDO instruction to the client, and performing step 1; and
step 5, writing certificate data in the writing certificate object instruction into the storage file, constituting response data according to a successful status code, generating a response to the preset FIDO instruction according to the response data, sending the response to the preset FIDO instruction to the client, and performing step 1.

16. A chip, coupled to a memory and is configured to execute a computer program stored in the memory to implement the method according to claim 1.

17. The security device according to claim 14, wherein the storage file is a container file, and the container file has a corresponding container identifier.

18. The security device according to claim 17, wherein the at least one processor executes the instructions to cause the processor to execute steps of:
generating the key pair and store the key pair in the container file corresponding to the container identifier in the certificate request generation instruction; or
writing the certificate data in the writing certificate object instruction into the container file corresponding to the container identifier in the writing certificate object instruction.

19. The security device according to claim 17, wherein the at least one processor executes the instructions to cause the processor to execute steps of:
determining whether there is the container file corresponding to the container identifier in the certificate request generation instruction, based on that there is the container file corresponding to the container identifier in the certificate request generation instruction, performing step 4, based on that there is not the container file corresponding to the container identifier in the certificate request generation instruction, creating the container file corresponding to the container identifier in the certificate request generation instruction and performing step 4.

20. The security device according to claim 18, wherein the at least one processor executes the instructions to cause the processor to execute steps of:
step 6, when the functional instruction is a reading certificate instruction, obtaining certificate data from a container file corresponding to a container identifier in the reading certificate instruction, sending the obtained certificate data to the client, and performing step 1;
step 7, when the functional instruction is a signature instruction: obtaining a container identifier and information to be signed from the signature instruction, reading a private key from a container file corresponding to a container identifier, signing the information to be signed according to the found private key to obtain a signature result, constituting a response to the preset FIDO instruction according to the signature result, sending the response to the preset FIDO instruction to the client, and performing step 1.

21. The security device according to claim 17, wherein the at least one processor executes the instructions to cause the processor to execute steps of:
when a second interface of the security device receives the instruction and a type of the received instruction is a reading certificate instruction, obtaining certificate data from a container file corresponding to the reading certificate instruction, returning the certificate data to the client, and performing step 1.
